(19) United States
(12) Patent Application Publication
(10) Pub. No.: US 2005/0081875 A1
(43) Pub. Date: Apr. 21, 2005

(54) Brush with combing members having ribs to facilitate combing of tangled hair strands

(76) Inventor: Huo-Pia Wang, Chang-Hua City (TW)

Correspondence Address: MERCHANT & GOULD PC, P.O. BOX 2903, MINNEAPOLIS, MN, 55402-0903, US

(21) Appl. No.: 10/690,026

(22) Filed: Oct. 20, 2003

(51) Int. Cl. A45D 24/00

(52) U.S. Cl. 132/219

(57) ABSTRACT

A brush includes a combing unit that projects outwardly from a mounting portion of a brush body, and that includes a plurality of spaced apart combing plates and a plurality of auxiliary combing members. Each of the auxiliary combing members is disposed between an adjacent pair of the combing plates, and has a plurality of ribs. Each of the ribs has a top portion. The top portions of each adjacent pair of the ribs angle away from each other to define a V-shaped groove therebetween.

### BACKGROUND OF THE INVENTION

1. Field of the Description

This invention relates to a brush, more particularly to a pet brush provided with combing member having ribs to facilitate combing and disentangling of tangled hair strands.

2. Description of the Related Art

Referring to FIG. 1, a conventional pet brush is shown to include a brush body 1 and a combing unit. The brush body 1 has a handgrip portion 11 and a mounting portion 12 extending from the handgrip portion 11 in a longitudinal direction. The combing unit includes a plurality of spaced-part combing plate 121 aligned in the longitudinal direction and mounted on and projecting outwardly from the mounting portion 12.

The conventional pet brush is disadvantageous in that it is difficult to disentangle tangled hair strands with the combing plates 121.

### SUMMARY OF THE INVENTION

The main object of this invention is to provide a pet brush with combing members having a plurality of ribs to facilitate combing and disentangling of tangled hair strands.

Accordingly, a brush of the present invention includes a brush body and a combing unit. The brush body includes a hand-grip portion and a mounting portion that extends from the hand-grip portion in a longitudinal direction. The combing unit is secured to and projects outwardly from the mounting portion, and includes a plurality of spaced apart combing plates and a plurality of auxiliary combing members. The combing plates are aligned in the longitudinal direction. Each of the auxiliary combing members is disposed between an adjacent pair of the combing plates, and has a plurality of ribs aligned in a transverse direction relative to the longitudinal direction. Each of the ribs has a top portion. The top portions of each adjacent pair of the ribs angle away from each other and defining a V-shaped groove therebetween.

### BRIEF DESCRIPTION OF THE DRAWINGS

These and other features and advantages of this invention will become apparent in the following detailed description of the preferred embodiment of this invention, with reference to the accompanying drawings, in which:

FIG. 1 is a schematic side view of a conventional brush for pets;

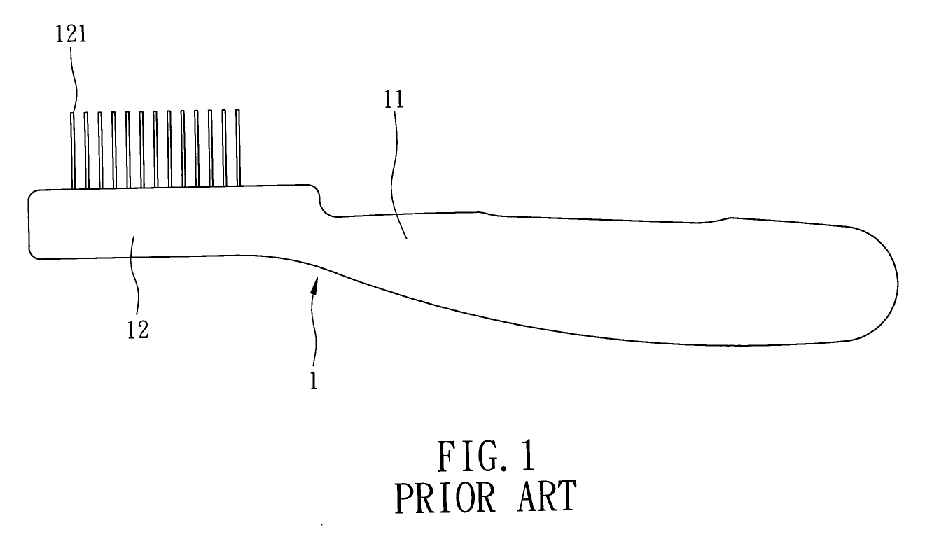

FIG. 2 is an exploded perspective view of the preferred embodiment of a pet brush according to the present invention;

FIG. 3 is a partly sectional side view illustrating a configuration of an auxiliary combing member that is mounted between an adjacent pair of combing plates of the preferred embodiment; and

FIG. 4 is a partly sectional view illustrating configurations of the combing member and the combing plate of the preferred embodiment.

### DETAILED DESCRIPTION OF THE PREFERRED EMBODIMENT

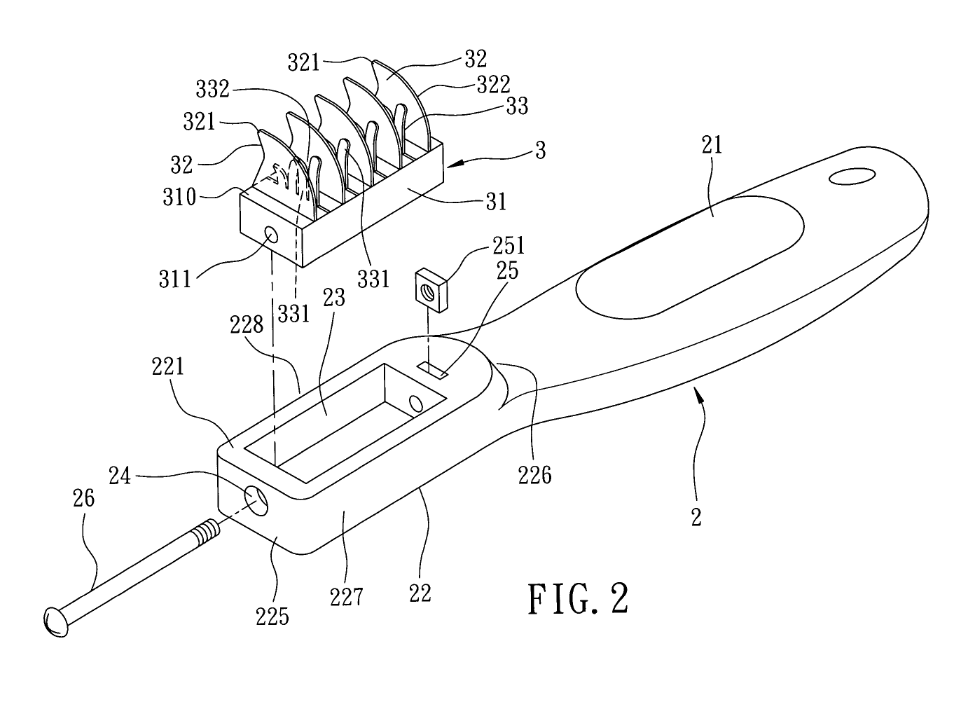

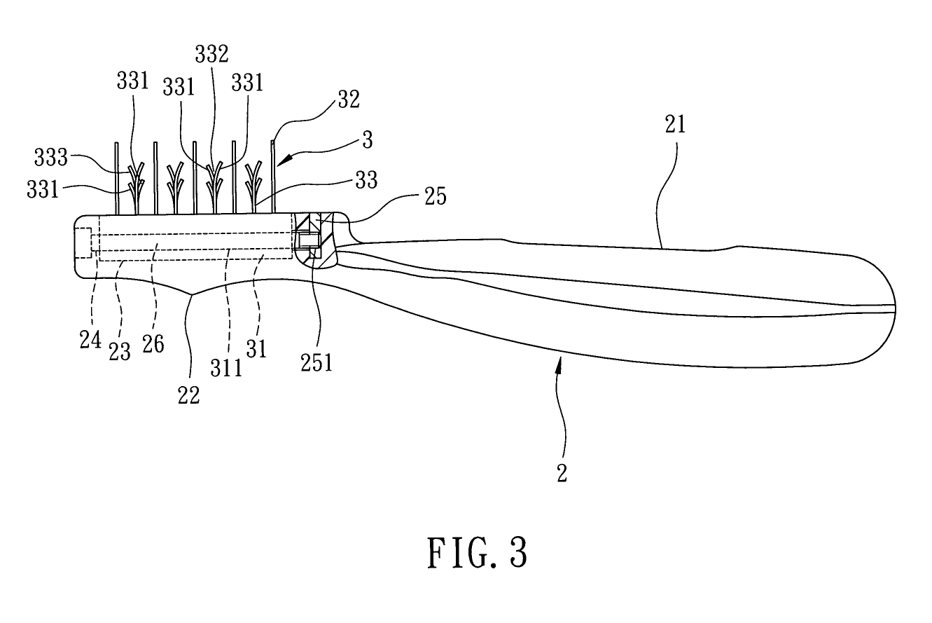

Referring to FIGS. 2 and 3, the preferred embodiment of a brush for pets according to the present invention is shown to include a brush body 2 and a combing unit 3.

As illustrated, the brush body 2 includes a hand-grip portion 21 and a mounting portion 22 that extends from the hand-grip portion 21 in a longitudinal direction. In this embodiment, the mounting portion 22 of the brush body 2 has a front end 225 distal from the hand-grip portion 21, a rear end 226 proximate to the hand-grip portion 21, a mounting face 221 that extends between the front and rear ends 225,226 and that is indented inwardly to define a receiving recess 23 in the mounting portion 22, and opposite left and right sides 227,228 extending in the longitudinal direction. The front end 225 of the mounting portion 22 of the brush body 2 is formed with a through-hole 24 which is in spatial communication with the receiving recess 23. The rear end 226 of the mounting portion 22 is formed with a nut-retention recess 25 which is aligned with the through-hole 24 in the longitudinal direction and which is in spatial communication with the receiving recess 23.

The combing unit 3 is secured to and projects outwardly from the mounting portion 22 of the brush body 2, and includes a plurality of spaced apart combing plates 32, a plurality of auxiliary combing members 33, and a positioning block 31. The positioning block 31 is received within the receiving recess 23 in the mounting portion 22, and has an upper surface 310 that is generally flush with the mounting face 221 of the mounting portion 22. A fastening bolt 26 extends through the through-hole 24 in the mounting portion 22 and a through-hole 311 in the positioning block 31, and engages threadedly a nut 251 that is received in the nut-retention recess 25 in the mounting portion 22 so as to prevent removal of the combing unit 3 from the mounting portion 22.

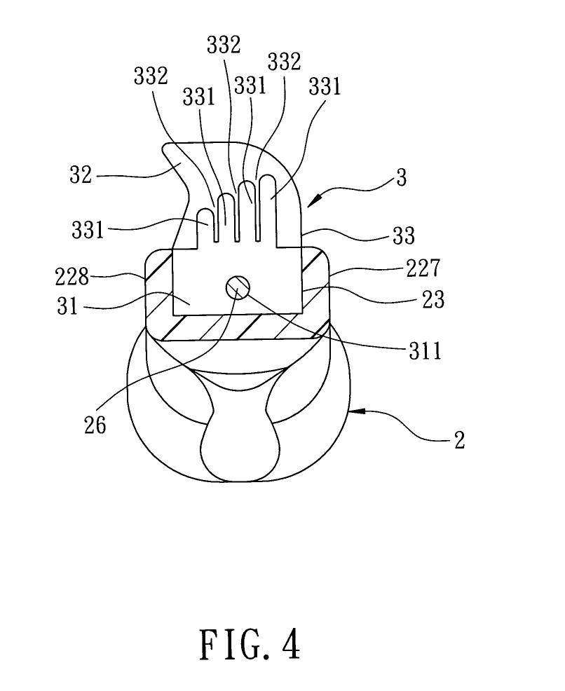

The combing plates 32 are aligned in the longitudinal direction. Each of the combing plates 32 is secured to the positioning block 31, projects upwardly from the upper surface 310 of the positioning block 31, and has a tip 321 distal from the upper surface 310 of the positioning block 31, and a curved edge 322 extending from the upper surface 310 of the positioning block 31 to the tip 321. Each of the auxiliary combing members 33 is disposed between an adjacent pair of the combing plates 32, and has a plurality of ribs 331 aligned in a transverse direction relative to the longitudinal direction. Each of the ribs 331 has a top portion 333. The top portions 333 of each adjacent pair of the ribs 331 angle away from each other, and define a V-shaped groove 332 therebetween. The ribs 331 are secured to the positioning block 31, and project upwardly from the upper surface 310 of the positioning block 31. The ribs 331 of the auxiliary combing members 33 gradually decrease in height relative to the upper surface 310 of the positioning block 31 from the leftmost one of the ribs 331 to the rightmost one of the ribs 331 (see FIG. 4). In addition, the top portions 333 of the ribs 331 are at a level lower than the tips 321 of the combing plates 32.

When the pet brush according to the present invention is used to comb or brush the hair strands of a pet, due to the configuration of the auxiliary combing members 33 and the arrangement of the auxiliary combing members 33 at a height lower than the combing plates 32, tangled hair strands of the pet can be disentangled easily.

Furthermore, in case the combing plates 32 or the ribs 331 of the auxiliary combing members 33 are damaged due to long term use, the combing unit 3 can be replaced with a new one in a convenient manner.

With this invention thus explained, it is apparent that numerous modifications and variations can be made without departing from the scope and spirit of this invention. It is therefore intended that the invention be limited only as indicated in the appended claims.

1. A brush comprising:
a brush body including a hand-grip portion and a mounting portion that extends from said hand-grip portion in a longitudinal direction; and
a combing unit secured to and projecting outwardly from said mounting portion, and including a plurality of spaced apart combing plates which are aligned in said longitudinal direction, and a plurality of auxiliary combing members, each of which is disposed between an adjacent pair of said combing plates, and each of which has a plurality of ribs aligned in a transverse direction relative to said longitudinal direction, each of said ribs having a top portion, said top portions of each adjacent pair of said ribs angling away from each other and defining a V-shaped groove therebetween.

2. The brush as defined in claim 1, wherein said mounting portion of said brush body has a front end distal from said hand-grip portion, a rear end proximate to said hand-grip portion, a mounting face extending between said front and rear ends and indented inwardly to define a receiving recess in said mounting portion, and opposite left and right sides extending in said longitudinal direction, said combing unit further including a positioning block that is received securely within said receiving recess and that has an upper surface, each of said combing plate being secured to and projecting upwardly from said upper surface of said positioning block, and having a tip distal from said upper surface of said positioning block, and a curved edge extending from said upper surface of said positioning block to said tip.

3. The brush as defined in claim 2, wherein each of said ribs is secured to said positioning block, projects upwardly from said upper surface of said positioning block, said ribs of each of said auxiliary combing members gradually decreasing in height relative to said upper surface of said positioning block from the leftmost one of said ribs to the rightmost one of said ribs.
